(19) United States
(12) Patent Application Publication
(10) Pub. No.: US 2024/0255457 A1
(43) Pub. Date: Aug. 1, 2024

(54) DEVICE FOR MONITORING THE STRUCTURE OF A SURFACE

(71) Applicant: TECHNISCHE HOCHSCHULE KÖLN, Köln (DE)

(72) Inventor: Patrick TICHELMANN, Gummersbach (DE)

(21) Appl. No.: 18/560,469

(22) PCT Filed: May 12, 2022
(86) PCT No.: PCT/EP2022/062895

§ 371 Date: Nov. 13, 2023

(30) Foreign Application Priority Data
May 14, 2021 (DE) 10 2021 112 608.8

(51) Int. Cl. G01N 27/20

(52) U.S. Cl. CPC G01N 27/20

(57) ABSTRACT

A device for structure monitoring of a surface to which the device can be applied, includes a carrier layer and a signal processing means, wherein the carrier layer is provided with electrical conductor paths, the signal processing means is electrically connected to the conductor paths for monitoring an electrical property of the conductor paths, the carrier layer to which the electrical conductor paths are applied is slotted, so that the carrier layer has openable cuts and the electrical conductor paths have openable contact points above it, so that when the cuts are closed the contact points are also closed and when the cuts are open the contact points are also open and thus the electrical conductor paths are reversibly interrupted, and the electrical property of the conductor paths monitored by the signal processing means is selected such that it has a different value for the case of closed contact points than for open contact points. In this way, a device for structure monitoring is provided which can be manufactured at low cost, can be used flexibly and can be reused.

The invention relates to a device for monitoring the structure of a surface to which the device can be applied, comprising a carrier layer and a signal processing means, the carrier layer being applied with electrical conductor paths and the signal processing means being electrically connected to the conductor paths in order to monitor an electrical property of the electrical conductor paths.

Structural monitoring of surfaces is used in many areas, e.g. in automotive engineering as well as in mechanical and plant engineering. Structural monitoring is understood to mean monitoring in which changes to the structure of a surface, such as cracks, dents and the like, can be detected and displayed. This should make it possible to display even the smallest changes that would otherwise remain undetected or would only be discovered at a later point in time, for example during maintenance.

In the automotive sector, around 447,000 new registrations of passenger cars with a hybrid drive were registered in the Federal Republic of Germany in the year 2020. It is expected that the demand for passenger cars with a purely electric or hybrid drive will continue to rise in the future. Special safety regulations apply to cars with a purely electric or partially electric drive with regard to the battery. The battery of a car is stored in a housing, also known as a “casing”. It is of particular interest to be able to detect damage to the battery casing in order to issue a warning to the driver, as a damaged battery casing represents a high safety risk. Bumps or other unevenness in the road surface can cause a car to “hit the ground”, i.e. touch the ground with individual components. This can lead to deformation of the battery housing in particular. If the deformation is too great, the battery housing hits the battery and can cause a subsequent fire. Consequently, it is of particular interest to be able to monitor the surface of the battery housing and issue a message if a limit deformation is exceeded.

Material testing methods for the non-destructive testing of components, such as ultrasound, X-ray and thermography, quickly reach their limits when it comes to assessing damage. One disadvantage of these methods is that they cannot be carried out during operation or require expensive testing equipment and complex testing procedures. The associated high costs for such structural monitoring systems are the reason why such structural monitoring is not used in everyday life. Therefore, there is a high demand for systems to monitor the state of a surface to be monitored, which systems can be provided at low cost.

The structural monitoring systems known from the state of the art typically require the structural monitoring systems to be integrated into the material to be monitored. For example, electrical conductors are incorporated into the material. Changes in the electrical properties of the conductors and breaks in the conductors indicate damage to the material to be monitored. In this regard, reference is made to EP 3 430 364 B1 as an example.

US 2017/0 048 965 A1 describes a flexible substrate for detecting deformation using a pattern formed of a conductive material. The deformation-detecting flexible substrate using the pattern formed of the conductive material includes a flexible substrate and conductive patterns in which conductors containing a conductive material are arranged and formed so as to be able to contact and not contact each other based on the deformation of the flexible substrate.

US 2020/0 240 763 A1 describes a sensor for detecting a bend in a flexible display device. The sensor comprises a first flexible base substrate and a first electrode layer on a side of the first flexible base substrate. The first electrode layer comprises an array of a plurality of first electrodes configured to detect a first bend in a first bending direction relative to a surface of the first flexible base substrate.

CN 1 11 722 723 A describes a bidirectional flexible bend sensor, a character speech recognition system and a character speech recognition method, wherein the bidirectional flexible bend sensor comprises a flexible substrate, array-type micropillars and a conductive layer, and the flexible substrate forms the bottom layer of the bidirectional flexible bend sensor.

DE 10 2013 006 809 A1 describes a battery for a motor vehicle, with at least one housing in which at least one storage element for storing electrical energy is accommodated, wherein at least one detection device is provided for detecting a deformation of at least a partial area of the housing.

These integrated structural monitoring systems have the disadvantage that the integration of the structural monitoring system into the material to be monitored is cost-intensive and time-consuming. They are therefore not suitable for widespread use in battery housings in cars with purely or partially electric drives, for example, as the high costs of these structural monitoring systems would not be affordable for the end user of the car.

Furthermore, an integrated structural monitoring system that has detected damage due to damage or breakage of the electrical conductors cannot be reused. However, this is very important in the case of elastic deformation of the surface to be monitored, for example. In fact, if the electrical conductors are damaged once, the structure monitoring system must be at least partially replaced. However, because the electrical conductors are integrated into the material, it is not easy to replace the electrical conductors in order to reuse the structure monitoring system.

The devices for structure monitoring known from the state of the art do not yet make it possible to provide a simple, cost-effective and reusable option for structure monitoring.

Based on this, it is the technical problem to be solved of the invention to provide a device for structure monitoring that is easy to assemble, can be manufactured at low cost and can also be reused in the event of elastic or repairable (denting) plastic deformation of the surface to be monitored.

This problem is solved by the object of claim 1. Preferred further embodiments can be found in the sub-claims.

According to the invention, a device for structure monitoring of a surface to which the device can be applied is thus provided, which comprises a carrier layer and a signal processing means. The carrier layer is provided with electrical conductor paths and the signal processing means for monitoring an electrical property of the conductor paths is electrically connected to these paths. The carrier layer to which the electrical conductor paths are applied is slotted, so that the carrier layer has openable cuts and the electrical conductor paths above it have openable contact points, so that when the cuts are closed the contact points are also closed and when the cuts are open the contact points are also open and thus the electrical conductor paths are reversibly interrupted. The electrical property of the conductor paths monitored by the signal processing means is selected in such a way that it has a different value for closed contact points than for open contact points.

It is therefore a main aspect of the invention that, due to the openable cuts and the overlying openable contact points of the conductor paths, which contact points open when the carrier layer is deformed, damage or deformation of the surface to be monitored can be detected via the changed electrical properties of the conductor paths, preferably with spatial and temporal resolution. If the damage, deformation or stretching of the surface to be monitored can be rectified, the cuts and contact points of the conductive paths can close again. This ensures the reuse or continued use of the device for structure monitoring. The components essential for monitoring, such as conductive paths and cuts, are arranged in or on the carrier layer and are not integrated into the surface to be monitored. This enables simple assembly, as the carrier layer can simply be applied to the surface to be monitored without the need to integrate the structure monitoring system. This enables a wide range of applications, as the device for structure monitoring can be applied to almost any surface where structure monitoring is required.

In the present case, the term “cut” is also understood to mean a slit or an elongated narrow opening in the carrier layer. The cuts are arranged in the carrier layer in such a way that they open when the carrier layer is deformed and are closed when it is not deformed.

When it is stated here that “the electrical conductor paths have openable contact points above them”, this means that the electrical conductor paths are arranged flat and in layers on the carrier layer and one contact point of the electrical conductor path is positioned above a cut or in the immediate vicinity to the side of the cut. This creates the effect in which opening the cut causes the contact point to open and thus the electrical conductor path to open. The cuts are oriented transverse or almost perpendicular to the longitudinal axis of the carrier layer.

According to a preferred embodiment of the invention, the carrier layer is designed such that it can assume a normal state and a deformed state, whereby in the normal state the cuts are closed and in the deformed state the cuts are open. The arrangement of carrier layer and electrical conductor paths is selected so that the cuts open when the carrier layer is deformed, thereby interrupting the electrical conductor paths. If the carrier layer is not deformed or has returned from the deformation to its original undeformed state, i.e. in the normal state, the cuts are closed or closed again so that the electrical conductor paths are also closed (again). This means that the device for structure monitoring can continue to be used as a sensor device after a reversible deformation because the interruptions in the electrical conductors can be closed again via the contact points.

According to a preferred embodiment of the invention, the carrier layer comprises a carrier plate or a carrier foil. As already explained, the carrier layer, i.e. in this case the carrier plate or carrier foil, comprises the conductor paths and the cuts. This makes it possible for the device to be manufactured cost-effectively and to be arranged on the surface to be monitored in a simple manner by applying the carrier film or carrier layer to the surface to be monitored. In particular, the carrier plate or carrier film is preferably designed to be cut to size so that it can be cut to fit the respective application and the surface to be monitored. Furthermore, the carrier plate or carrier film can be arranged on almost any surface, in particular on large-area structures. This enables versatile use of the device for structure monitoring.

In principle, it is possible to arrange individual conductive paths in different orientations on the carrier layer. According to a preferred embodiment of the invention, however, it is provided that the electrical conductor paths are arranged in a first group and in a second group which is different from the first group, the electrical conductor paths of the first group running in a first direction, the electrical conductor paths of the second group running in a direction different from the first direction and intersecting the electrical conductor paths of the first group and thus, together with the conductor paths of the first group, forming a network of n row conductors and m column conductors, and a diode is arranged in each intersection region of an electrical conductor path of the first group with an electrical conductor path of the second group, the connection between row conductor and column conductor being produced by means of the diode, so that a network is formed in the form of a diode matrix.

The individual electrical conductor paths are therefore arranged in a matrix circuit. This ensures that the reliability of the structure monitoring is not reduced even if the surface to be monitored is damaged or deformed. The step-by-step scanning of the conductor paths via the row and column conductors of the diode matrix makes it possible to localize an open cut or an open contact point. It should be mentioned that the matrix circuit is only to be understood here as a circuit arrangement. It is not necessary for the row and column conductors to be arranged in a regular grid distribution. Nor do they have to run in a straight line and parallel or perpendicular to each other. It is only necessary that the contact points of the row and column conductors are arranged above the cuts. Consequently, the arrangement of the row and column conductors depends on the positioning of the cuts in the carrier layer.

In electrical engineering, the diode matrix mentioned above is also referred to as a passive matrix, which can be connected using a variety of available integrated components. In a matrix configuration, each crossing point of the matrix can be controlled individually by activating a corresponding column driver in conjunction with the activation of a corresponding row driver. Therefore, in a preferred embodiment, each intersection is controlled by the signal processing means by means of row and column drivers. The task of the row and column drivers is to cyclically control the electrodes of the diodes with different voltages of different polarity. Preferably, the row and column drivers are designed as shift registers. Shift registers belong to the logic modules and enable the parallel output of a serial data stream. A resulting advantage is that microcontrollers can be used with significantly fewer inputs/outputs than there are rows and columns. Preferably, the signal processing means is designed as an application-specific integrated circuit.

According to a preferred embodiment of the invention, the cuts in the first direction and/or in the second direction are arranged at varying distances from one another in the carrier layer. The positioning of the cuts, in particular the distances between the cuts, can be adapted in particular to the shape and the conditions of the structure of the surface to be monitored.

The fact that the position of the electrical conductor paths depends on the position of the cuts means that the distance between the row conductors or the distance between the column conductors or the distance between both the row and column conductors also varies across the surface of the carrier layer. The density of the cuts and thus the density of the control points can be adjusted depending on the structure to be monitored, so that areas in which the deformation is to be monitored more precisely can also have a higher density of cuts.

In principle, it is possible within the scope of the invention for the cuts to have various lengths. According to a preferred embodiment of the invention, the cuts have a length of <1 cm, preferably <0.5 cm, most preferably <0.1 cm. The length of the cuts in this case refers to the depth of the cuts in the carrier layer. In principle, the sensitivity of the device can be controlled via the length of the cuts. Depending on the length of the cuts, the cut can open with a stronger or weaker deformation, so that the opening of the contact points of the electrical conductors depends, among other things, on the length of the cuts in combination with the degree of damage or deformation.

According to the invention, there is also provided an arrangement for structure monitoring with the device described above, comprising a carrier layer, signal processing means and a surface to be monitored, the surface to be monitored being exposed to the carrier layer.

Preferably, the deformability is adapted to the surface to be monitored. The deformability of the carrier layer is firmly defined by a predetermined limit deformation. Depending on the deformability of the carrier layer, the structure monitoring can be made more sensitive or more robust. If even the smallest damage to the surface to be monitored is to be detected, the carrier layer has a high deformability so that it deforms even with the smallest damage. However, if only major damage to the surface to be monitored is to be detected, the carrier layer has a low deformability so that it only deforms in the event of more severe damage. It is preferable that the deformability varies over the entire surface of the carrier layer, so that there are areas in which the deformability is low and there are areas in which the deformability is high.

The carrier layer is arranged flat on the surface to be monitored. The carrier layer is fixed to the surface to be monitored, for example by bonding, so that contact between the carrier layer and the surface to be monitored is ensured over the entire area of the carrier layer and reliable structural monitoring can therefore be provided.

The intended use of the device described above involves monitoring the structure of a surface to be monitored. For this purpose, in a first step, after the device has been positioned on the surface to be monitored, a voltage is applied to the electrical conductor paths by means of the signal processing means. The current flow is then measured by the signal processing means via the electrical conductors. Damage—if present—can then be detected due to an interruption of the current flow through an open contact point of an electrical conductor path. The damage can be harm, deformation or stretching, provided that the cuts in the carrier layer are opened as a result.

The damage can be localized via a diode matrix. For this purpose, in a first step, a voltage is applied to the diode matrix by means of the signal processing means via the electrical conductor paths of a first group and the electrical conductor paths of a second group in such a way that the diodes of the diode matrix connected in the crossing area of the electrical conductor paths of a first group and the electrical conductor paths of a second group are operated in the reverse direction. The polarity of the voltage for an electrical conductor path of a first group and an electrical conductor path of a second group is then reversed, whereby the diode connected in the crossing area of the electrical conductor path of a first group and an electrical conductor path of a second group is operated in the forward direction. In parallel, the current flow is measured by the signal processing means via the electrical conductor path of a first group, the diode connected in the forward direction at the crossing point and the electrical conductor paths of a second group. The previous steps are repeated to scan the individual matrix areas, whereby the electrical conductor path of the first and/or second group is different from the previous measurement when the current flow is measured again using the signal processing means.

Consequently, in order to check the continuity of a conductor path via the row conductors and column conductors of the diode matrix, the latter is energized in such a way that the diodes are operated in the reverse direction, while the diode matrix is energized in the reverse direction, i.e. in the forward direction of the diodes, in order to check the integrity of a specific conductor path and thus the integrity of the surface to be monitored for one row and one column in each case, so that a continuity test can be carried out. With this sensor arrangement for structure monitoring, a diode matrix with up to n times m crossing points can be scanned, whereby damage can be precisely localized by testing the conductor paths step by step via the row conductors and column conductors of the diode matrix.

Preferably, the total power consumption of the sensor arrangement for structural monitoring of the surface to be monitored is measured. As the power consumption of the electronics is very low compared to the sensor, damage to the surface to be monitored or an open contact point can be registered very quickly.

In the following, the invention is explained further with reference to the drawings by means of a preferred embodiment of the invention.

In the drawings

FIG. 1 schematically depicts a sectional view of a device for structure monitoring according to a preferred embodiment in a normal state,

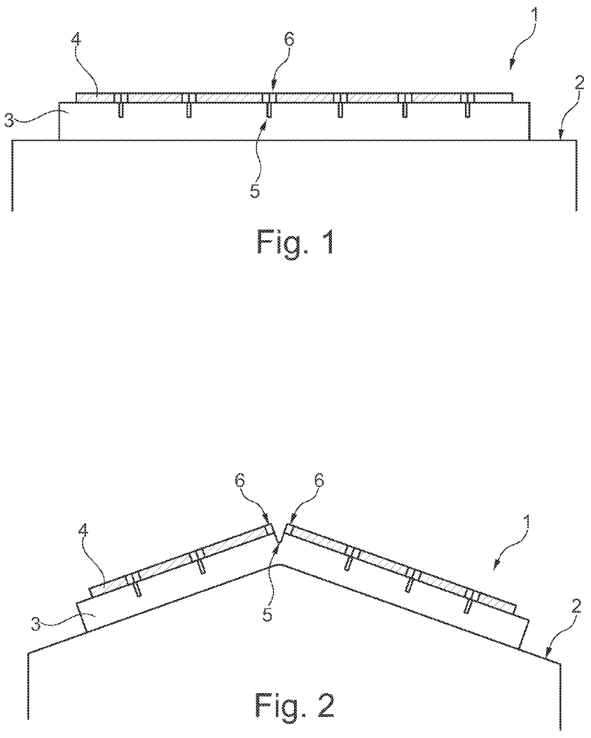

FIG. 2 schematically depicts a sectional view of the structural monitoring device according to a preferred embodiment in a deformed state,

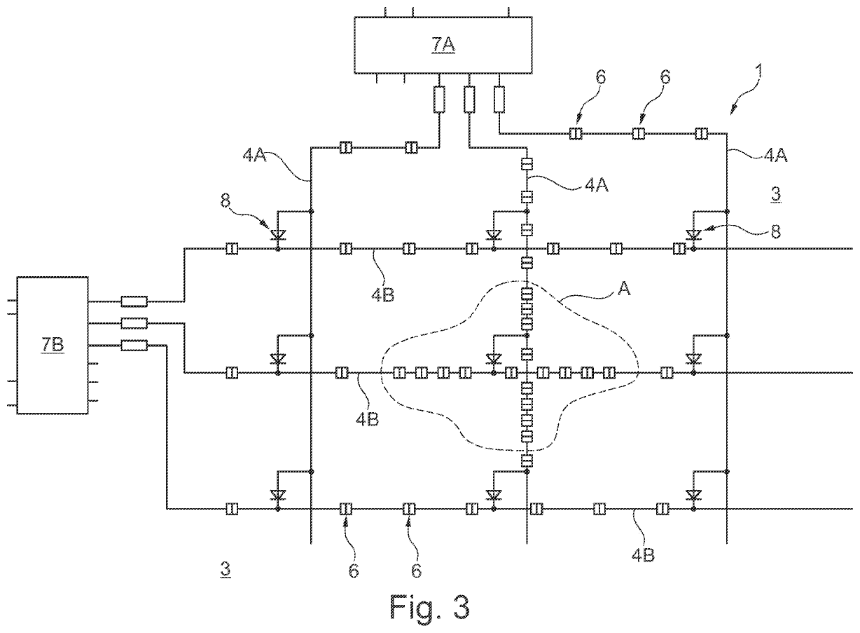

FIG. 3 schematically depicts a top view of a device for structure monitoring according to a further preferred embodiment in a normal state.

FIG. 1 shows a device for structure monitoring 1 according to a preferred embodiment. The device 1 is shown in FIG. 1 in an undeformed normal state. In this state, the device 1 is applied to the surface 2 to be monitored. The surface 2 to be monitored shows no damage, deformation or stretching. It is therefore in a target state. The carrier layer 3 is arranged on the surface 2 to be monitored. Electrical conductor paths 4 are arranged on the carrier layer 3. The carrier layer 3 comprises several cuts 5. In the embodiment example shown here, the cuts 5 are arranged at a regular distance from one another. However, the distance between the cuts 5 can also vary. The electrical conductor paths 4 have contact points 6. These contact points make it possible for the respective electrical conductor path 4 to be opened from a closed state and then closed again. The electrical conductor paths 4 are arranged on the carrier layer 3 in such a way that one contact point 6 is positioned above each cut 5.

FIG. 2 shows the device for structure monitoring 1 from FIG. 1 in a deformed state. The surface 2 to be monitored is deformed by an outwardly oriented bump. The deformation of the surface 2 to be monitored also deforms the carrier layer 3 so that a cut 5 opens. Due to the opened cut 5, the overlying contact point 6 of the respective electrical conductor path 4 also opens, so that a current flow through this electrical conductor path 4 is interrupted. If the deformation of the surface 2 to be monitored is rectified, the surface 2 and the carrier layer 3 return to the normal state shown in FIG. 1.

FIG. 3 shows a device for structure monitoring 1 according to a further embodiment example in the form of a diode matrix. The electrical conductor paths 4A, 4B are arranged on the carrier layer 3 in such a way that they form a network of column conductors 4A and row conductors 4B. A diode 8 is arranged at each crossing point, whereby the diode 8 establishes the connection between column conductors 4A and row conductors 4B, so that a network in the form of a diode matrix is formed. Several contact points 6 are provided along the electrical conductor paths 4A, 4B. These contact points 6 are arranged above cuts not shown in FIG. 3. FIG. 3 makes it clear that the cuts and the contact points 6 above them do not have to be arranged at a regular distance from each other. In order to be able to monitor the monitoring area of particular interest A as precisely as possible, the cuts and contact points 6 are arranged more densely in this monitoring area A. If the surface to be monitored is damaged in such a way that the cuts open, the contact points 6 above them also open. Damage can now be detected by the fact that each diode 8 located in the crossing points can be controlled by the signal processing means by means of row driver 7B and column driver 7A, and changes in the current flow through the row conductor 4B and column conductor 4A can be measured.

### LIST OF REFERENCE SYMBOLS

1 Device for structure monitoring
2 Surface to be monitored
3 Carrier layer
4 Electrical conductor path
4A electrical conductor path of the first group
4B Electrical conductor path of the second group
5 Cutting
6 Contact point
7A Signal processing means as a column driver
7B Signal processing means as a row driver
8 Diode
A Monitoring area of special interest

1. Device for structure monitoring of a surface to which the device can be applied, comprising a carrier layer and a signal processing means, wherein:
the carrier layer is provided with electrical conductor paths,
the signal processing means is electrically connected to the conductor paths for monitoring an electrical property of the electrical conductor paths,
the carrier layer to which the electrical conductor paths are applied is slotted, so that the carrier layer has openable cuts and the electrical conductor paths have openable contact points above it, so that when the cuts are closed the contact points are also closed and when the cuts are open the contact points are also open and thus the electrical conductor paths are reversibly interrupted, and
the electrical property of the conductor paths monitored by the signal processing means is selected such that it has a different value for the case of closed contact points than for open contact points.

2. Device according to claim 1, wherein the carrier layer is designed in such a way that it can assume a normal state and a deformed state, wherein in the normal state the cuts are closed and in the deformed state the cuts are open.

3. Device according to claim 1, wherein the carrier layer comprises a carrier plate or a carrier film.

4. Device according to claim 1, wherein the electrical conductor paths are arranged in a first group and in a second group different from the first group, wherein:
the electrical conductor paths of the first group run in a first direction,
the electrical conductor paths of the second group run in a direction different from the first direction and intersect the electrical conductor paths of the first group and thus, together with the conductor paths of the first group, form a network of n row conductors and m column conductors, and
a diode is arranged in each crossing region of an electrical conductor path of the first group with an electrical conductor path of the second group, the connection between row conductor and column conductor being established by means of the diode, so that a network is formed in the form of a diode matrix.

5. Device according to claim 4, wherein each crossing area can be controlled by the signal processing means by means of row drivers and column drivers.

6. Device according to claim 1, wherein the cuts are arranged in at least one of the first direction or in the second direction at varying distances from one another in the carrier layer.

7. Device according to claim 1, wherein the cuts have a length of <1 cm.

8. Arrangement for structure monitoring with a device according to claim 1, comprising a carrier layer, a signal processing means, and a surface to be monitored, wherein the surface to be monitored is exposed to the carrier layer.

9. Arrangement according to claim 8, wherein the surface is formed by at least a part of the surface of a battery housing.
